(19) United States
(12) Patent Application Publication
(10) Pub. No.: US 2019/0320124 A1
(43) Pub. Date: Oct. 17, 2019

(54) ELECTRONIC DEVICE, CONTROL DEVICE, CONTROL METHOD, AND CONTROL PROGRAM

(71) Applicant: SHARP KABUSHIKI KAISHA, Sakai City (JP)

(72) Inventors: CHIKAO MIZUGUCHI, Sakai City (JP); JUNICHI SUDA, Sakai City (JP); KAIJI NABETANI, Sakai City (JP); YUSUKE OKUDA, Sakai City (JP)

(21) Appl. No.: 16/379,043

(22) Filed: Apr. 9, 2019

(30) Foreign Application Priority Data
Apr. 13, 2018 (JP) 2018-077780

(51) Int. Cl. H04N 5/232

(52) U.S. Cl. CPC H04N 5/232939; H04N 5/23245

(57) ABSTRACT

When a still image has been captured is determined within a display screen on which a moving image is displayed. A control device executes: a thumbnail displaying process for causing a thumbnail of a still image captured during capture of a moving image to be displayed at a predetermined position within a display screen; and a thumbnail moving process for moving this thumbnail.

This Nonprovisional application claims priority under U.S.C. § 119 on Patent Application No. 2018-077780 filed in Japan on Apr. 13, 2018, the entire contents of which is hereby incorporated by reference.

### TECHNICAL FIELD

The present invention relates to an electronic device, a control device, a control method, and a control program.

### BACKGROUND ART

Patent Literature 1 discloses the following technique. That is, (a) at least one of (i) a relational content related to a content in whole or in part to be processed after changed and to a content in whole or in part that was subject to processing before changed and (ii) a relational content related to the content in whole or in part to be processed after changed and (b) the content to be processed after changed are each symbolically laid out in a virtual space. The virtual space is visualized in a displayable state and displayed on the display means. According to the technique disclosed in Patent Literature 1, relevance between the contents that can change over time can be visualized according to their changes.

### CITATION LIST

### Patent Literature

[Patent Literature 1]

Japanese Patent Application Publication Tokukai No. 2010-204942 (Publication date: Sep. 16, 2010)

### SUMMARY OF INVENTION

### Technical Problem

The technique disclosed in Patent Literature 1 gives rise to a problem that during generation of contents which can change over time, another image cannot be visualized. Thus, in the technique disclosed in Patent Literature 1, the function of capturing a still image during capture of a moving image cannot cause the still image to be displayed within the display screen on which the moving image is displayed.

Conventionally, the above function merely enables a thumbnail of a single still image captured most recently to be displayed within a display screen on which a moving image is displayed. Thus, it is not possible to determine when the still image has been captured within the display screen on which a moving image is displayed.

It is an object of an aspect of the present invention to realize an electronic device, a control device, a control method, and a control program, each of which makes it possible to determine when a still image has been captured, within the display screen on which a moving image is displayed.

### Solution to Problem

In order to solve the above-mentioned problems, an electronic device in accordance with an aspect of the present invention is an electronic device including: at least one image capturing device; at least one display device; and at least one control device, the control device being configured to execute: a thumbnail displaying process for causing a thumbnail of a still image captured by the image capturing device during capture of a moving image by the image capturing device to be displayed at a predetermined position within a display screen of the display device on which display screen the moving image being captured by the image capturing device is displayed; and a thumbnail moving process for moving the thumbnail displayed in the thumbnail displaying process.

In order to solve the above-mentioned problems, a control device in accordance with an aspect of the present invention is a control device for controlling an electronic device, the electronic device including at least one image capturing device and at least one display device, the control device including: a thumbnail displaying section configured to cause a thumbnail of a still image captured by the image capturing device during capture of a moving image by the image capturing device to be displayed at a predetermined position within a display screen of the display device on which display screen the moving image being captured by the image capturing device is displayed; and a thumbnail moving section configured to move the thumbnail displayed by the thumbnail displaying section.

In order to solve the above-mentioned problems, a control method in accordance with an aspect of the present invention is a control method for controlling an electronic device, the electronic device including: at least one image capturing device; and at least one display device, the control method comprising the steps of: (a) causing a thumbnail of a still image captured by the image capturing device during capture of a moving image by the image capturing device to be displayed at a predetermined position within a display screen of the display device on which display screen the moving image being captured by the image capturing device is displayed; and (b) moving the thumbnail displayed in the step (a).

In order to solve the above-mentioned problems, a control program in accordance with an aspect of the present invention is a control program for controlling the above-mentioned image capturing device, the control program causing a computer to function as the above-mentioned control device.

### Advantageous Effects of Invention

According to an aspect of the present invention, it is possible to determine when a still image has been captured, within the display screen on which a moving image is displayed.

### BRIEF DESCRIPTION OF DRAWINGS

FIG. 1 is a block diagram schematically illustrating configurations of a control device and an electronic device in accordance with an embodiment of the present invention.

FIG. 2 is a flow chart showing the flow of operations of the control device and the electronic device illustrated in FIG. 1.

FIG. 3 is a view illustrating a conceptual screenshot of operations performed by the control device and the electronic device illustrated in FIG. 1 and illustrating the display screen before the capture of a moving image is started.

FIG. 4 is a view illustrating a conceptual screenshot of operations performed by the control device and the electronic device illustrated in FIG. 1 and illustrating the display screen after the capture of a moving image is started and before a still image is captured.

FIG. 5 is a view illustrating a conceptual screenshot of operations performed by the control device and the electronic device illustrated in FIG. 1 and illustrating the display screen after a still image has been captured and before a thumbnail of a still image is scaled down.

FIG. 6 is a view illustrating a conceptual screenshot of operations performed by the control device and the electronic device illustrated in FIG. 1 and illustrating the display screen after a still image has been captured and immediately after a thumbnail of the still image has been scaled down.

FIG. 7 is a view illustrating a conceptual screenshot of operations performed by the control device and the electronic device illustrated in FIG. 1 and illustrating the display screen after a lapse of 10 seconds from the state illustrated in FIG. 6.

FIG. 8 is a view illustrating a conceptual screenshot of operations performed by the control device and the electronic device illustrated in FIG. 1 and illustrating the display screen after a lapse of 20 seconds from the state illustrated in FIG. 7.

FIG. 9 is a view illustrating a conceptual screenshot of operations performed by the control device and the electronic device illustrated in FIG. 1 and illustrating the display screen after a still image has been captured after the state illustrated in FIG. 8 and before the thumbnail of the still image is scaled down.

FIG. 10 is a view illustrating a conceptual screenshot of operations performed by the control device and the electronic device illustrated in FIG. 1 and illustrating the display screen after a still image has been captured after the state illustrated in FIG. 8 and immediately after the thumbnail of the still image has been scaled down.

FIG. 11 is a view illustrating a conceptual screenshot of operations performed by the control device and the electronic device illustrated in FIG. 1 and illustrating the display screen after a lapse of 50 seconds from the state illustrated in FIG. 10.

FIG. 12 is a view illustrating a conceptual screenshot of operations performed by the control device and the electronic device illustrated in FIG. 1 and illustrating the display screen after a lapse of 10 seconds from the state illustrated in FIG. 11.

### DESCRIPTION OF EMBODIMENTS

### Embodiment 1

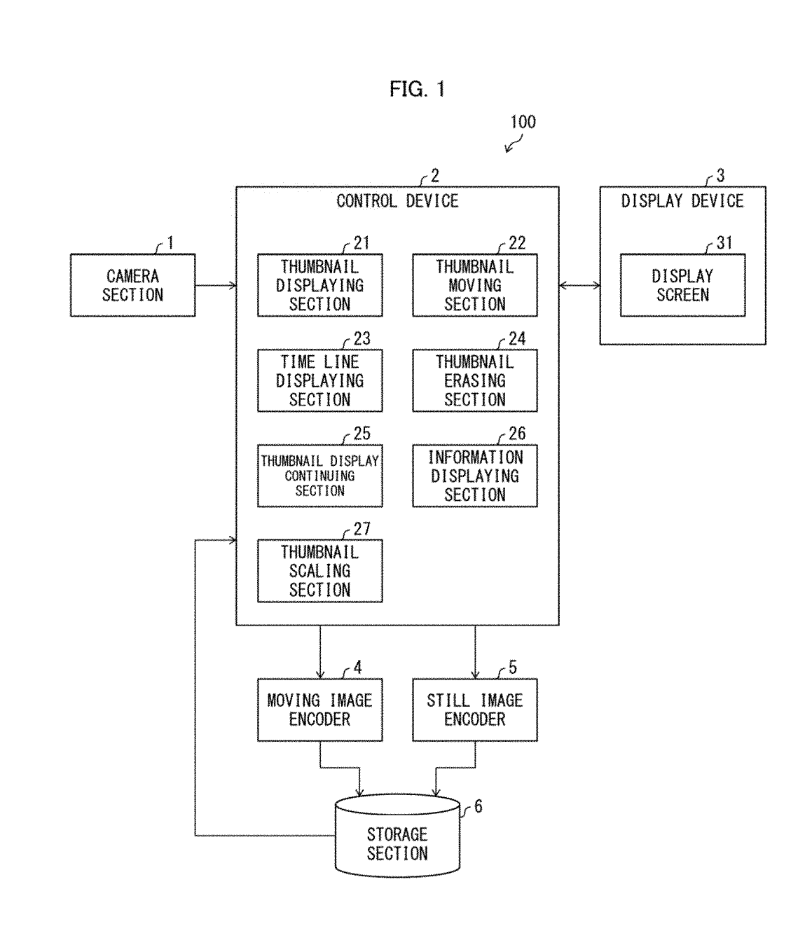

The following description will discuss embodiments for carrying out the present invention. FIG. 1 is a block diagram schematically illustrating configurations of a control device 2 and an electronic device 100 in accordance with an embodiment of the present invention.

The electronic device 100 includes a camera section (image capturing device) 1, a control device 2, a display device 3, a moving image encoder 4, a still image encoder 5, and a storage section 6. The control device 2 is constituted by, for example, a central processing unit (CPU) or a digital signal processor (DSP). The control device 2 includes a thumbnail displaying section 21, a thumbnail moving section 22, a time line displaying section 23, a thumbnail erasing section 24, a thumbnail display continuing section 25, an information displaying section 26, and a thumbnail scaling section 27. The display device 3 includes a display screen 31.

The camera section 1 has a moving image capturing function of the electronic device 100 and a still image capturing function of the electronic device 100. The camera section 1 may be constituted by a single camera module having both the moving image capturing function and the still image capturing function. Alternatively, the camera section 1 may be constituted by a camera module having the moving image capturing function and a camera module having the still image capturing function.

The moving image encoder 4 carries out encoding and multiplexing of a moving image captured by the camera section 1, and stores data of the moving image subjected to encoding and multiplexing in the storage section 6. The still image encoder 5 carries out encoding of a still image captured by the camera section 1, and stores data of the still image subjected to encoding in the storage section 6. The storage section 6 is constituted by, for example, a flash memory, a random access memory (RAM), or an SD card.

The thumbnail displaying section 21 executes a thumbnail displaying process. In the thumbnail displaying process, a thumbnail of a still image captured by the electronic device 100 during capture of a moving image by the electronic device 100 is displayed at a predetermined position within the display screen 31 on which the moving image being captured by the electronic device 100 is displayed. The thumbnail moving section 22 executes a thumbnail moving process. In the thumbnail moving process, a thumbnail of a still image displayed by the thumbnail displaying section 21 (in the thumbnail displaying process) is moved at a constant velocity along a predetermined path. The time line displaying section 23 executes a time line displaying process. In the time line displaying process, a time line extending from the predetermined position as a starting point along the predetermined path is displayed within the display screen 31. Note that the time line is a straight line representing a time base. The time line may be graduated to indicate elapsed times. The thumbnail erasing section 24 executes a thumbnail erasing process. In the thumbnail erasing process, a thumbnail of a still image is erased from within the display screen 31 when the thumbnail of the still image has moved to an ending point of the time line. The thumbnail display continuing section 25 executes a thumbnail display continuing process. In the thumbnail display continuing process, a thumbnail of a still image is caused to continue to be displayed within the display screen 31 when the thumbnail of the still image has moved to the ending point of the time line. In the thumbnail display continuing process, when the camera section 1 captures a plurality of still images, respective thumbnails originating from the still images thus captured are displayed in a superimposed manner.

The display device 3 displays, on the display screen 31, an image caught by the camera section 1 and icons for instructing execution of various functions of the electronic device 100, and is also called a view display monitor. When each of the icons displayed on the display screen 31 is pressed, the display device 3 can execute a corresponding one of the functions associated with the icons. That is, the display device 3 is a touch panel system that causes the display screen 31 to function as a touch panel. The information displaying section 26 executes an information displaying process. In the information displaying process, when a part on which the thumbnail of the still image is displayed within the display screen 31 is touched (i.e., when an object is brought into contact with the thumbnail displayed part), the information on the still image corresponding to the thumbnail is displayed within the display screen 31. The thumbnail scaling section 27 executes a thumbnail scaling process. In the thumbnail scaling process, when a part on which the thumbnail of the still image is displayed within the display screen 31 is touched, the thumbnail is scaled up and/or scaled down.

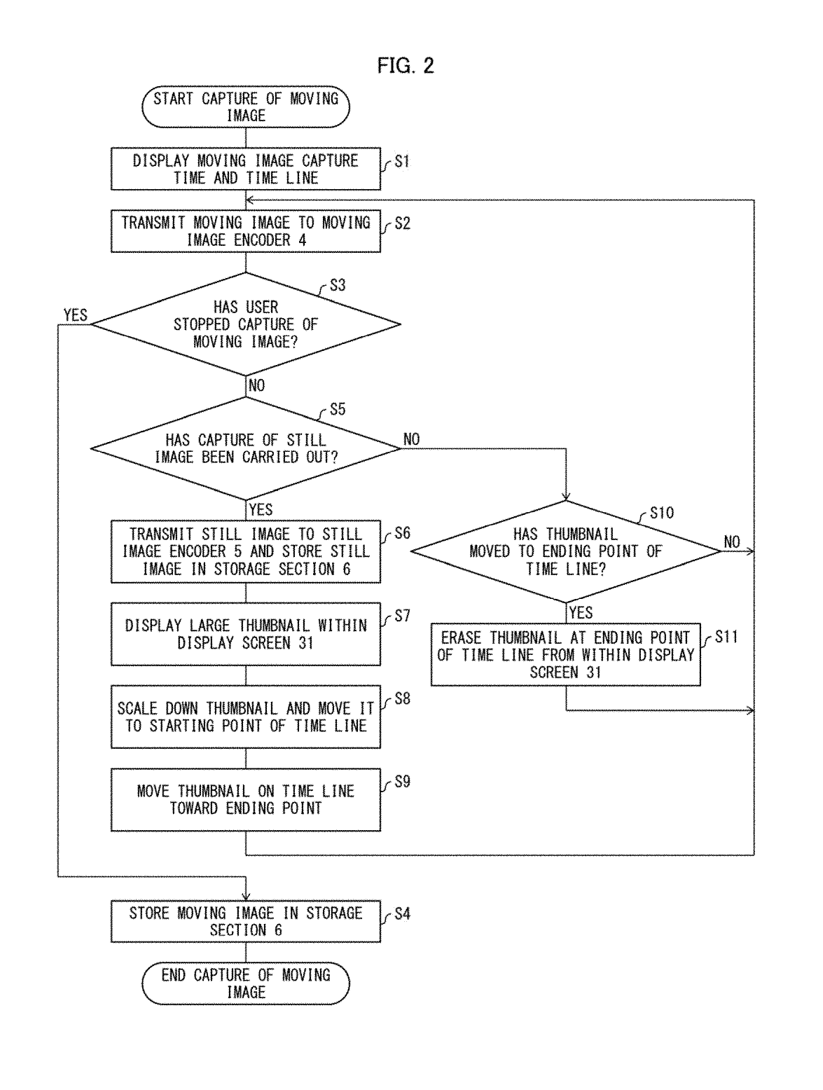

FIG. 2 is a flow chart showing the flow of operations of the control device 2 and the electronic device 100. First, after capture of a moving image is started, the time line displaying section 23 causes a time line to be displayed on the display screen 31 (step S1). In the step S1, the time line displaying section 23 causes the amount of time elapsed from the start of the moving image capture (moving image capture time) to be displayed on the display screen 31.

Subsequently, the control device 2 transmits a moving image captured by the camera section 1 to the moving image encoder 4 (step S2). A technique by which the control device 2 carries out the step S2 falls within the scope of the well-known technique, and therefore detailed description of the technique is omitted. Subsequently, the control device 2 determines whether the capture of the moving image by the camera section 1 has been stopped (step S3). A technique by which the control device 2 carries out the step S3 falls within the scope of the well-known technique, and therefore detailed description of the technique is omitted. In a case where the capture of the moving image by the camera section 1 has been stopped (the result in the step S3 is YES), the moving image encoder 4 carries out encoding and multiplexing of the moving image, and stores data of the moving image subjected to encoding and multiplexing in the storage section 6 (step S4). After the step S4, the capture of the moving image is finished.

In a case where the capture of the moving image by the camera section 1 has not been stopped (the result in the step S3 is NO), the control device 2 determines whether the capture of a still image by the camera section 1 has been carried out (step S5). A technique by which the control device 2 carries out the step S5 falls within the scope of the well-known technique, and therefore detailed description of the technique is omitted.

In a case where the capture of the still image by the camera section 1 has been carried out (the result in the step S5 is YES), the control device 2 transmits the still image to the still image encoder 5, and the still image encoder 5 carries out encoding of the still image and stores data of the still image subjected to encoding in the storage section 6 (step S6). A technique by which the control device 2 carries out an operation corresponding to the step S6 falls within the scope of the well-known technique, and therefore detailed description of the technique is omitted. Subsequently, the control device 2 causes a thumbnail of the still image to be displayed within the display screen 31 (step S7). A technique by which the control device 2 carries out the step S7 falls within the scope of the well-known technique, and therefore detailed description of the technique is omitted. It should be noted that the size of the thumbnail displayed within the display screen 31 in the step S7 is large enough to occupy most of the display screen 31.

Subsequently, the thumbnail displaying section 21 reduces the size of the thumbnail displayed within the display screen 31 in the step S7, and moves (displays) the thumbnail to the starting point of the time line (step S8). Subsequently, the thumbnail moving section 22 causes the thumbnail having been moved to the starting point of the time line to be moved along the time line at a constant velocity (step S9). After the step S9, the process proceeds to the step S2.

In a case where the capture of the still image by the camera section 1 has not been carried out (the result in the step S5 is NO), the thumbnail erasing section 24 determines whether the thumbnail has been moved to the ending point of the time line (step S10). In a case where the thumbnail has been moved to the ending point of the time line (the result in the step S10 is YES), the thumbnail erasing section 24 erases the thumbnail from within the display screen 31 (step S11). In a case where the thumbnail has not been moved to the ending point of the time line (the result in the step S10 is NO), or after the step S11, the process proceeds to the step S2.

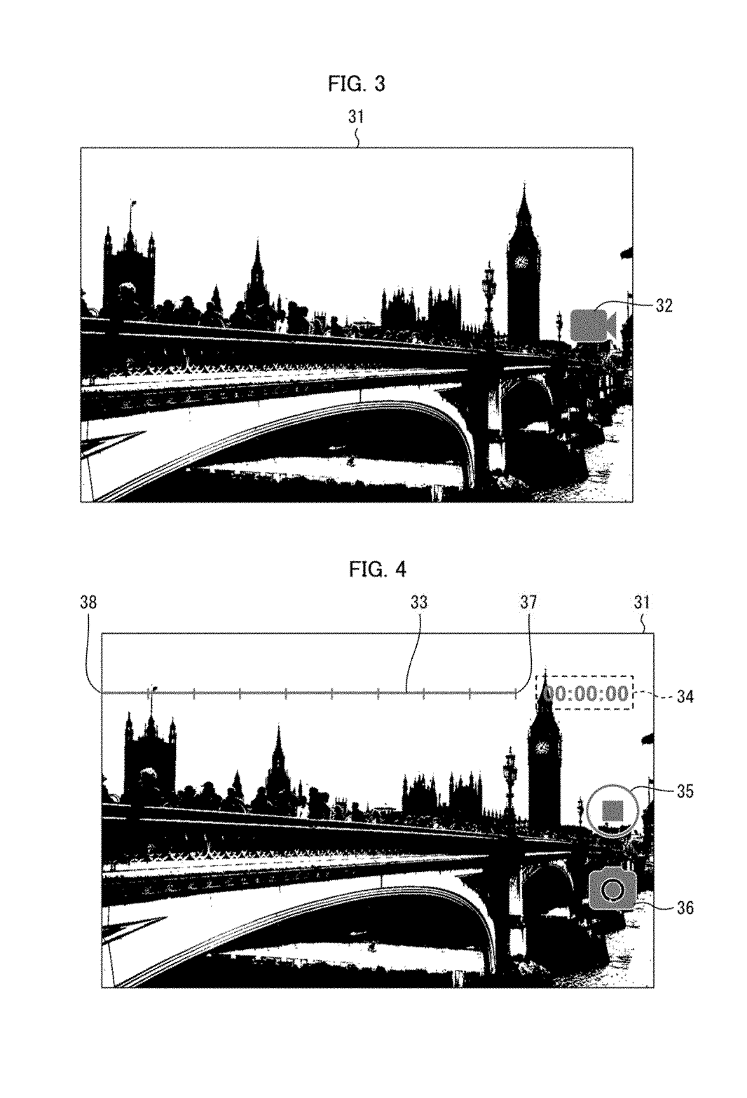

The following description will discuss a more specific conception of the operations performed by the control device 2 and the electronic device 100, with reference to the content displayed within the display screen 31. FIG. 3 is a view illustrating a conceptual screenshot of operations performed by the control device 2 and the electronic device 100 and illustrating the display screen 31 before the capture of a moving image is started. Within the display screen 31, a moving image capture start icon 32 is displayed together with an image caught by the camera section 1. When the moving image capture start icon 32 is pressed, the capture of a moving image by the camera section 1 is started.

FIG. 4 is a view illustrating a conceptual screenshot of operations performed by the control device 2 and the electronic device 100 and illustrating the display screen 31 after the capture of a moving image is started and before a still image is captured. Within the display screen 31 are displayed, together with an image caught by the camera section 1, a time line 33 displayed by the time line displaying section 23, an elapsed time 34 from the start of the capture of a moving image, a moving image capture end icon 35, and a still image capture icon 36. The time line 33 extends from a starting point 37, which is provided within the display screen 31 at the upper right (corresponding to the predetermined position) when viewed from the front of the display screen 31, to an ending point 38, which is provided within the display screen 31 at the upper left when viewed from the front thereof, in a direction from the right side of the display screen 31 to the left side thereof (corresponding to a route along the predetermined path). When the moving image capture end icon 35 is pressed, the capture of the moving image by the camera section 1 is finished. When the still image capture icon 36 is pressed, the capture of a still image by the camera section 1 is carried out. In the electronic device 100, pressing the still image capture icon 36 while the capture of the moving image by the camera section 1 is maintained allows the camera section 1 to capture a still image while capturing the moving image.

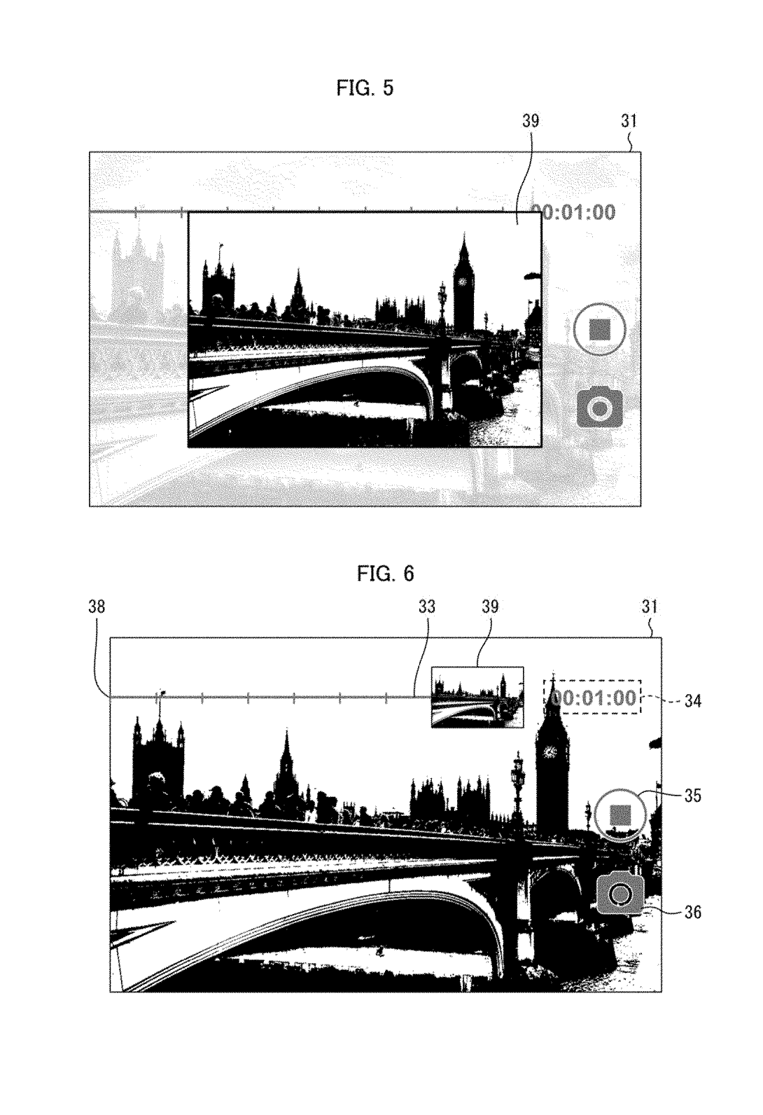

FIG. 5 is a view illustrating a conceptual screenshot of operations performed by the control device 2 and the electronic device 100 and illustrating the display screen 31 after a still image has been captured and before a thumbnail 39 of the still image is scaled down. Within the display screen 31, the thumbnail 39 is displayed in a size large enough to occupy most of the display screen 31.

FIG. 6 is a view illustrating a conceptual screenshot of operations performed by the control device 2 and the electronic device 100 and illustrating the display screen 31 after a still image has been captured and immediately after a thumbnail 39 of the still image has been scaled down. FIG. 6 illustrates a state in which the thumbnail displaying section 21 reduces the size of the thumbnail 39 and moves the thumbnail 39 to the starting point 37 of the time line 33.

It should be noted that displaying the thumbnail 39 in a size large enough to occupy most of the display screen may be omitted. In such a case, the thumbnail displaying section 21 moves a thumbnail 39 already having a small size at a point in time when the thumbnail 39 is displayed within the display screen 31 to the starting point 37 of the time line 33. The same applies to a thumbnail 40 described later.

Further, the starting point 37 of the time line 33 may be located within the display screen 31 at a position other than the upper right when viewed from the front of the display screen 31. For example, the starting point 37 of the time line 33 may be located within the display screen 31 at the lower right when viewed from the front of the display screen 31, may be located within the display screen 31 near the center of the display screen 31, or may be located within the display screen 31 at the left when viewed from the front of the display screen 31. The direction in which the time line 33 extends is not limited to the right-to-left direction when viewed from the front of the display screen 31, and may be any direction. That is, the time line 33 can be placed in any layout within the display screen 31. Further, one time line 33 may be displayed in a form of a plurality of line segments into which the time line 33 is divided. Alternatively, a plurality of time lines 33 may be displayed so that, for example, a plurality of thumbnails 39 can be moved to individual starting points 37 of the separate time lines 33 in a one-to-one correspondence.

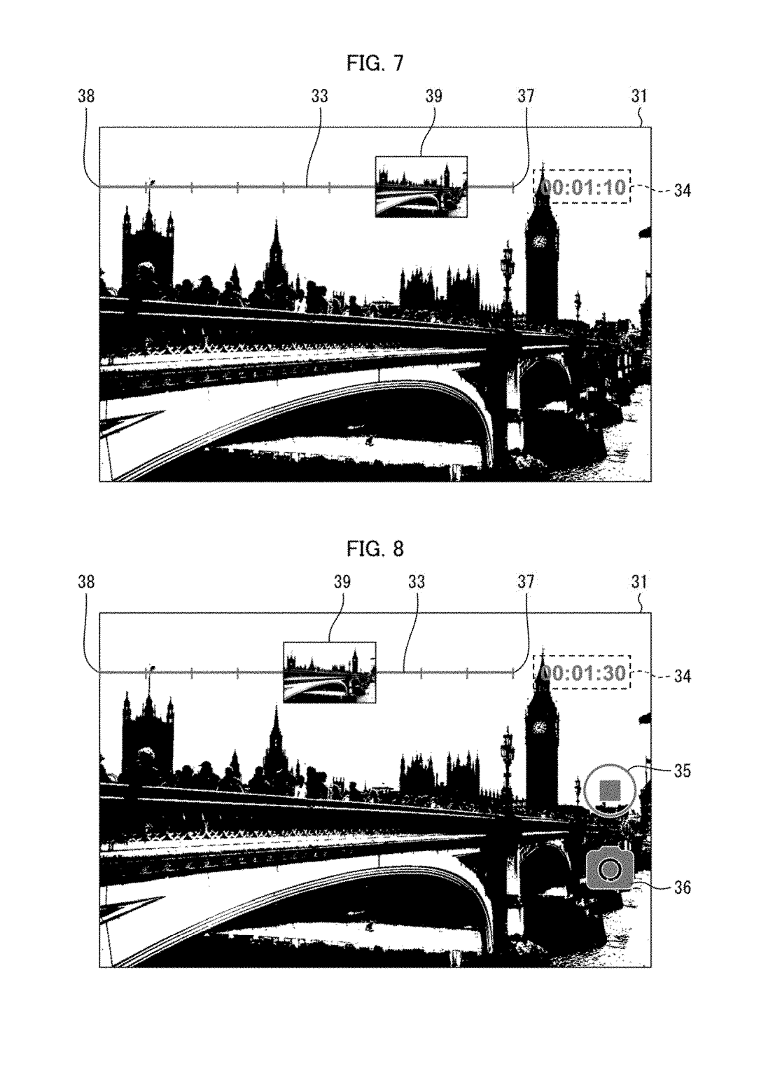

FIG. 7 is a view illustrating a conceptual screenshot of operations performed by the control device 2 and the electronic device 100 and illustrating the display screen 31 after a lapse of 10 seconds from the state illustrated in FIG. 6. FIG. 8 is a view illustrating a conceptual screenshot of operations performed by the control device 2 and the electronic device 100 and illustrating the display screen 31 after a lapse of 20 seconds from the state illustrated in FIG. 7. FIGS. 7 and 8 each illustrate a state in which the thumbnail moving section 22 causes the thumbnail 39 to be moved along the time line 33 at a constant velocity. For example, assuming that one graduation of the time line 33 is 10 seconds, the thumbnail 39 in FIG. 8 is moved by three graduations of the time line 33 from the starting point 37 of the time line 33.

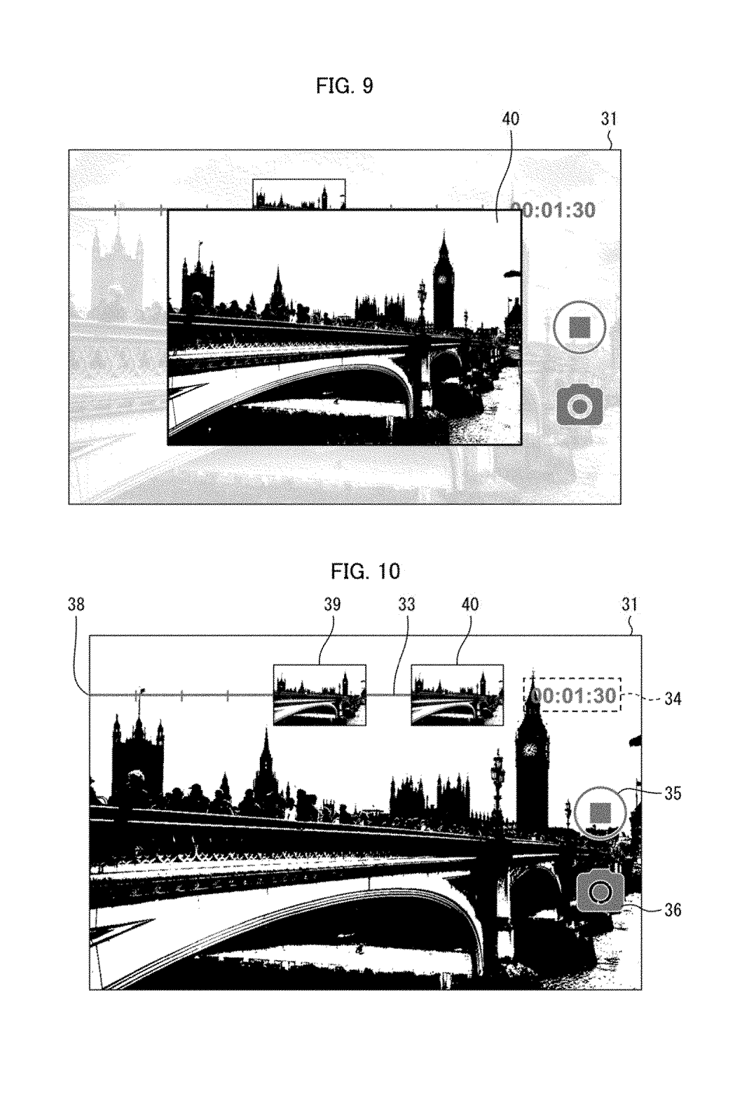

FIG. 9 is a view illustrating a conceptual screenshot of operations performed by the control device 2 and the electronic device 100 and illustrating the display screen 31 after a still image has been captured after the state illustrated in FIG. 8 and before the thumbnail 40 of the still image is scaled down. Within the display screen 31, the thumbnail 40 is displayed in a size large enough to occupy most of the display screen 31.

FIG. 10 is a view illustrating a conceptual screenshot of operations performed by the control device 2 and the electronic device 100 and illustrating the display screen 31 after a still image has been captured after the state illustrated in FIG. 8 and immediately after the thumbnail of the still image has been scaled down. FIG. 10 illustrates a state in which the thumbnail displaying section 21 reduces the size of the thumbnail 40 and moves the thumbnail 40 to the starting point 37 of the time line 33.

FIG. 11 is a view illustrating a conceptual screenshot of operations performed by the control device 2 and the electronic device 100 and illustrating the display screen 31 after a lapse of 50 seconds from the state illustrated in FIG. 10. FIG. 11 illustrates a state in which the thumbnail moving section 22 moves the thumbnails 39 and 40 at a constant velocity along the time line 33. The moving velocity of the thumbnail 39 along the time line 33 is the same as the moving velocity of the thumbnail 40 along the time line 33. For example, assuming that one graduation of the time line 33 is 10 seconds, the thumbnail 39 in FIG. 11 is moved by 8 graduations of the time line 33 from the starting point 37 of the time line 33, and the thumbnail 40 in FIG. 11 is moved by 5 graduations of the time line 33 from the starting point 37 of the time line 33.

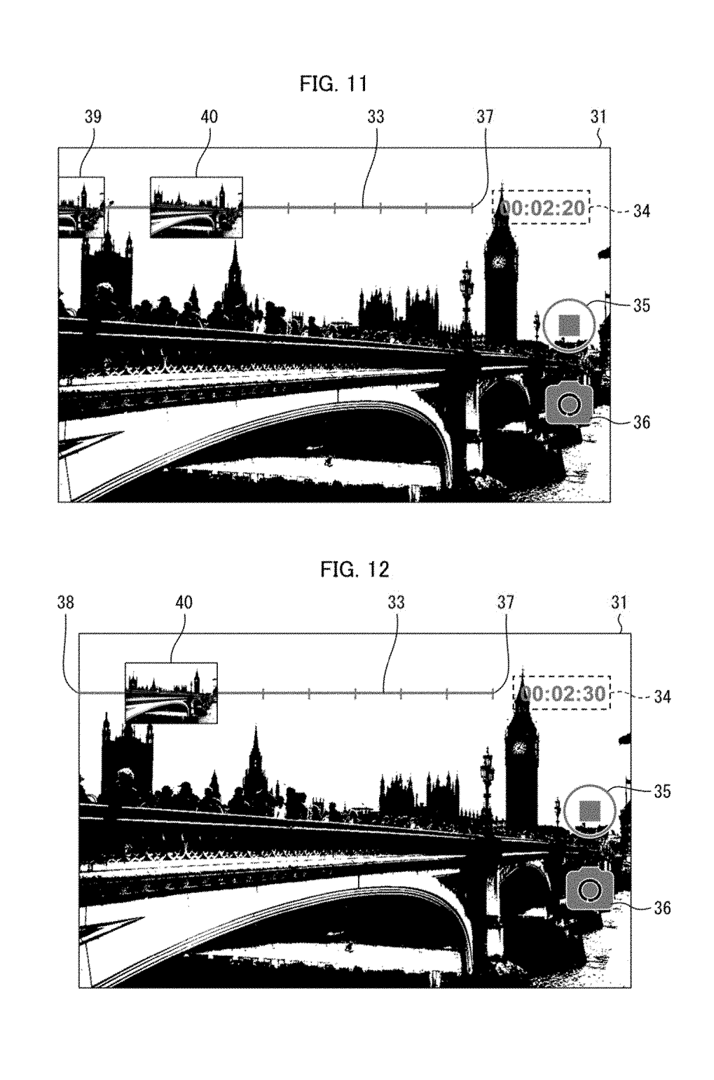

FIG. 12 is a view illustrating a conceptual screenshot of operations performed by the control device 2 and the electronic device 100 and illustrating the display screen 31 after a lapse of 10 seconds from the state illustrated in FIG. 11. FIG. 12 illustrates an example in which an interval between the starting point 37 and the ending point 38 of the time line 33 corresponds to 90 seconds, namely, an example in which the thumbnail of the still image is erased 90 seconds after the still image has been captured. FIG. 12 illustrates a state in which the thumbnail erasing section 24 causes the thumbnail 39 to be erased from within the display screen 31 by providing a visual effect such that the thumbnail 39 is moved leftward so as to be moved outside the display screen 31.

The visual effect, provided by the thumbnail erasing section 24, for erasing the thumbnail 39 from within the display screen 31 is not particularly limited. For example, the thumbnail erasing section 24 may erase the thumbnail 39 from within the display screen 31 in such a manner that the thumbnail 39 fades out.

Further, in FIG. 12, instead of the thumbnail erasing section 24 erasing the thumbnail 39 from within the display screen 31, the following process may be performed by the thumbnail display continuing section 25. That is, when the thumbnail 39 moves to the ending point 38 of the time line 33, the thumbnail display continuing section 25 causes the thumbnail 39 to continue to be displayed within the display screen 31. Thereafter, when the thumbnail 40 moves to the ending point 38 of the time line 33, the thumbnail display continuing section 25 causes the thumbnail 40 to continue to be displayed within the display screen 31. At this time, the thumbnail display continuing section 25 superimposes the thumbnail 39 and the thumbnail 40 and displays them on or near the ending point 38 of the time line 33, for example.

Further, when a part on which the thumbnail 39 is displayed within the display screen 31 is touched, the information displaying section 26 may cause information on the still image corresponding to the thumbnail 39 to be displayed within the display screen 31. Examples of the information include a date and time when an image is captured and a data size. Further, when a part on which the thumbnail 39 is displayed within the display screen 31 is touched, the thumbnail scaling section 27 may scale up the thumbnail 39 or scale down the thumbnail 39. The same applies to the thumbnail 40.

The control device 2 and the electronic device 100 are each configured such that the thumbnail displaying section 21 and the thumbnail moving section 22 execute the thumbnail displaying process and the thumbnail moving process, respectively. Thus, the thumbnails 39 and 40 are each moved at a constant velocity along the time line 33 from the starting point 37 of the time line 33 within the display screen 31 on which a moving image is displayed, so that the thumbnails 39 and 40 are each displayed within the display screen 31 in such a state as to be associated with an elapsed time from the start of the capture of the moving image. Thus, it is possible to determine, on the basis of the respective positions of the thumbnails 39 and 40, when the still images corresponding to the thumbnails 39 and 40 have been captured, within the display screen 31 on which the moving image is displayed.

The control device 2 and the electronic device 100 are each configured such that the time line displaying section 23 executes the time line displaying process. Thus, each of the thumbnails 39 and 40 can be moved along the time line 33 within the display screen 31 on which the moving image is displayed. Thus, it is possible to more easily determine when the still images corresponding to the thumbnails 39 and 40 have been captured, within the display screen 31.

The control device 2 and the electronic device 100 are each configured such that the thumbnail erasing section 24 executes the thumbnail erasing process. Thus, the thumbnails 39 and 40 can be erased from within the display screen 31. This makes it possible to prevent viewability of the display screen 31 from being impaired by a large number of thumbnails displayed within the display screen 31.

The control device 2 and the electronic device 100 are each configured such that the thumbnail display continuing section 25 executes the thumbnail display continuing process. Thus, the thumbnail 39 and the thumbnail 40 can be displayed in a superimposed manner within the display screen 31. Thus, it is possible to prevent viewability of the display screen 31 from being impaired even if a large number of thumbnails are displayed within the display screen 31.

The control device 2 and the electronic device 100 are each configured such that the information displaying section 26 executes the information displaying process. Thus, information on the still image corresponding to the thumbnail 39 can be displayed within the display screen 31. The same applies to the thumbnail 40.

The control device 2 and the electronic device 100 are each configured such that the thumbnail scaling section 27 executes the thumbnail scaling process. Thus, the thumbnail 39 can be scaled up and/or scaled down. The same applies to the thumbnail 40.

### Embodiment 2

Control blocks of the control device 2 may be implemented by hardware such as DSP or may be implemented by software.

In the latter case, the electronic device 100 includes a computer that executes instructions of a program that is software realizing the foregoing functions. The computer includes, for example, at least one processor and at least one computer-readable storage medium storing the program. An object of the present invention can be achieved by the processor reading and executing the program stored in the storage medium. Examples of the processor encompass a CPU. Examples of the storage medium encompass “a non-transitory tangible medium” such as a read only memory (ROM) or the like, a tape, a disk, a card, a semiconductor memory, and a programmable logic circuit. The electronic device 1 can further include a random access memory (RAM) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An electronic device in accordance with a first aspect of the present invention is an electronic device including: at least one image capturing device (camera section 1); at least one display device; and at least one control device, the control device being configured to execute: a thumbnail displaying process for causing a thumbnail of a still image captured by the image capturing device during capture of a moving image by the image capturing device to be displayed at a predetermined position within a display screen of the display device on which display screen the moving image being captured by the image capturing device is displayed; and a thumbnail moving process for causing the thumbnail displayed in the thumbnail displaying process to be moved at a constant velocity along a predetermined path.

According to the above configuration, a thumbnail of a still image is moved at a constant velocity along a predetermined path from the predetermined position within the display screen on which a moving image is displayed, so that the thumbnail is displayed within the display screen in such a state as to be associated with an elapsed time from the start of the capture of the moving image. Thus, it is possible to determine, on the basis of the position of the thumbnail, when the still image has been captured, within the display screen on which the moving image is displayed.

In a second aspect of the present invention, the electronic device can be arranged such that, in the first aspect of the present invention, the control device executes a time line displaying process for displaying a time line within the display screen, the time line extending from the predetermined position as a starting point along the predetermined path.

According to the above configuration, the thumbnail of the still image can be moved along the time line within the display screen on which a moving image is displayed. Thus, it is possible to more easily determine when the still image has been captured, within the display screen.

In a third aspect of the present invention, the electronic device can be arranged such that, in the second aspect of the present invention, the control device executes a thumbnail erasing process for erasing the thumbnail from within the display screen when the thumbnail has moved to an ending point of the time line.

According to the above configuration, the thumbnail of the still image can be erased from within the display screen. This makes it possible to prevent viewability of the display screen from being impaired by a large number of thumbnails displayed within the display screen.

In a fourth aspect of the present invention, the electronic device can be arranged such that, in the second aspect of the present invention, the control device executes a thumbnail display continuing process for causing the thumbnail to continue to be displayed within the display screen when the thumbnail has moved to an ending point of the time line, and in the thumbnail display continuing process, respective thumbnails originating from a plurality of still images are displayed in a superimposed manner.

According to the above configuration, a plurality of thumbnails can be displayed in a superimposed manner within the display screen. Thus, it is possible to prevent viewability of the display screen from being impaired even if a large number of thumbnails are displayed within the display screen.

In a fifth aspect of the present invention, the electronic device can be arranged such that, in any one of the first to fourth aspects of the present invention, the control device executes an information displaying process for, when an object is brought into contact with a part on which the thumbnail is displayed within the display screen, displaying within the display screen information on the still image corresponding to the thumbnail.

According to the above configuration, information on the still image corresponding to the thumbnail can be displayed within the display screen.

In a sixth aspect of the present invention, the electronic device can be arranged such that, in any one of the first to fifth aspects of the present invention, the control device executes a thumbnail scaling process for carrying out at least one of scale-up of the thumbnail and scale-down of the thumbnail when an object is brought into contact with a part on which the thumbnail is displayed within the display screen.

According to the above configuration, the thumbnail can be scaled up and/or scaled down.

A control device in accordance with a seventh aspect of the present invention is a control device for controlling an electronic device, the electronic device including at least one image capturing device and at least one display device, the control device including: a thumbnail displaying section configured to cause a thumbnail of a still image captured by the image capturing device during capture of a moving image by the image capturing device to be displayed at a predetermined position within a display screen of the display device on which display screen the moving image being captured by the image capturing device is displayed; and a thumbnail moving section configured to cause the thumbnail displayed by the thumbnail displaying section to be moved at a constant velocity along a predetermined path.

According to the above configuration, it is possible to realize a control device which allows a user to determine when a still image has been captured, within the display screen on which a moving image is displayed.

A control method in accordance with an eighth aspect of the present invention is a control method for controlling an electronic device, the electronic device including: at least one image capturing device; and at least one display device, the control method comprising the steps of: (a) causing a thumbnail of a still image captured by the image capturing device during capture of a moving image by the image capturing device to be displayed at a predetermined position within a display screen of the display device on which display screen the moving image being captured by the image capturing device is displayed; and (b) moving the thumbnail displayed in the step (a) at a constant velocity along a predetermined path.

According to the above configuration, it is possible to realize a control method by which when a still image has been captured can be determined within the display screen on which a moving image is displayed.

A control program in accordance with a ninth aspect of the present invention is a control program for controlling an electronic device in accordance with any one of the first to sixth aspects, the control program causing a computer to function as a control device.

According to the above configuration, it is possible to realize a control program by which when a still image has been captured can be determined within the display screen on which a moving image is displayed.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: Camera section (image capturing device)
2: Control device
3: Display apparatus
21: Thumbnail display section
22: Thumbnail moving section
23: Time line displaying section
24: Thumbnail erasing section
25: Thumbnail display continuing section
26: Information displaying section
27: Thumbnail scaling section
31: Display screen
33: Time line
37: Starting point of time line
38: Ending point of time line
39, 40: Thumbnail
100: Electronic device

1. An electronic device comprising:
at least one image capturing device;
at least one display device; and
at least one control device,
the control device being configured to execute:
a thumbnail displaying process for causing a thumbnail of a still image captured by the image capturing device during capture of a moving image by the image capturing device to be displayed at a predetermined position within a display screen of the display device on which display screen the moving image being captured by the image capturing device is displayed; and
a thumbnail moving process for moving the thumbnail displayed in the thumbnail displaying process.

2. The electronic device according to claim 1, wherein the control device causes the thumbnail to be moved at a constant velocity in the thumbnail moving process.

3. The electronic device according to claim 1, wherein the control device causes the thumbnail to be moved along a predetermined path in the thumbnail moving process.

4. The electronic device according to claim 3, wherein the control device executes a time line displaying process for displaying a time line within the display screen, the time line extending from the predetermined position as a starting point along the predetermined path.

5. The electronic device according to claim 4, wherein the control device executes a thumbnail erasing process for erasing the thumbnail from within the display screen when the thumbnail has moved to an ending point of the time line.

6. The electronic device according to claim 4, wherein the control device executes a thumbnail display continuing process for causing the thumbnail to continue to be displayed within the display screen when the thumbnail has moved to an ending point of the time line, and in the thumbnail display continuing process,
respective thumbnails originating from a plurality of still images are displayed in a superimposed manner.

7. The electronic device according to claim 1, wherein the control device executes an information displaying process for, when an object is brought into contact with a part on which the thumbnail is displayed within the display screen, displaying within the display screen information on the still image corresponding to the thumbnail.

8. The electronic device according to claim 1, wherein the control device executes a thumbnail scaling process for carrying out at least one of scale-up of the thumbnail and scale-down of the thumbnail when an object is brought into contact with a part on which the thumbnail is displayed within the display screen.

9. A control device for controlling an electronic device, the electronic device comprising: at least one image capturing device; and at least one display device,
the control device comprising:
a thumbnail displaying section configured to cause a thumbnail of a still image captured by the image capturing device during capture of a moving image by the image capturing device to be displayed at a predetermined position within a display screen of the display device on which display screen the moving image being captured by the image capturing device is displayed; and
a thumbnail moving section configured to move the thumbnail displayed by the thumbnail displaying section.

10. A control method of controlling an electronic device, the electronic device comprising: at least one image capturing device; and at least one display device, the control method comprising the steps of:
(a) causing a thumbnail of a still image captured by the image capturing device during capture of a moving image by the image capturing device to be displayed at a predetermined position within a display screen of the display device on which display screen the moving image being captured by the image capturing device is displayed; and
(b) moving the thumbnail displayed in the step (a).

11. A control program for controlling an electronic device recited in claim 1, the control program causing a computer to function as a control device.
